(19) United States
(12) Patent Application Publication
(10) Pub. No.: US 2024/0220346 A1
(43) Pub. Date: Jul. 4, 2024

(54) ON-BOARD DEVICE AND ON-BOARD DEVICE SELF-DIAGNOSIS METHOD

(71) Applicant: Panasonic Automotive Systems Co., Ltd., Kanagawa (JP)

(72) Inventors: Kiyotaka TANIMOTO, Kanagawa Ken (JP); Fumio KOSUGE, Kanagawa Ken (JP); Toshihiko MORI, Kanagawa Ken (JP)

(73) Assignee: Panasonic Automotive Systems Co., Ltd., Kanagawa (JP)

(21) Appl. No.: 18/609,455

(22) Filed: Mar. 19, 2024

Related U.S. Application Data
(63) Continuation of application No. PCT/JP2022/036281, filed on Sep. 28, 2022.

(30) Foreign Application Priority Data
Oct. 29, 2021 (JP) 2021-178299

(51) Int. Cl. G06F 11/07

(52) U.S. Cl. CPC G06F 11/0769

(57) ABSTRACT

An on-board device according to the present disclosure, which enables a GNSS receiver to receive GNSS data and is connectable to both a constant power supply line and an ACC power supply line, includes a memory and first and second processors coupled to the memory. The first processor is configured to determine a status of the GNSS receiver when power is supplied to the ACC power supply line. The second processor is configured to: determine whether the on-board device is connected to the constant power supply line based on the status of the GNSS receiver; and in response to determining that the on-board device is not connected to the constant power supply line, make a report that the on-board device is not connected to the constant power supply line.

### CROSS-REFERENCE TO RELATED APPLICATIONS

This application is a continuation of International Application No. PCT/JP2022/036281, filed on Sep. 28, 2022 which claims the benefit of priority of the prior Japanese Patent Application No. 2021-178299, filed on Oct. 29, 2021, the entire contents of which are incorporated herein by reference.

### FIELD

Embodiments described herein relate generally to an on-board device and an on-board device self-diagnosis method.

### BACKGROUND

Conventionally, there have been known on-board devices equipped with a global navigation satellite system (GNSS), such as GPS.

Vehicles equipped with such an on-board device are provided with services such as operation management or vehicle management using data of GNSS satellites. In order to be provided with such services, data needs to be transmitted from a vehicle side, and this has incurred a high communication charge. Incidentally, as an example of a recent on-board device, on-board devices that correspond to ETC 2.0 have been known. Such the on-board devices perform communication with a server in normal processing, and therefore the services described above can be provided by using a communication network with the server. Conventional technologies are described in JP 4593101 B2, for example.

However, in order to be provided with accurate services, GNSS data without omissions needs to be provided from an on-board device side to a server side, and in a case where the GNSS data has omissions, there has been a possibility that accurate services will fail to be provided.

There are various conceivable reasons why the GNSS data has omissions, and an example of a cause on the on-board device side in an on-board device that corresponds to ETC 2.0 is that a constant power supply line is not connected to the on-board device, almanac data, ephemeris data, or the like required to measure the GNSS data (GNSS positioning data) is invalid immediately after an accessory power supply (hereinafter, referred to as an ACC) has been turned on, and this causes positioning data to fail to be immediately received.

Even in such a case, if the on-board device is connected via an ACC key, it takes time to acquire accurate GNSS data, but after the accurate GNSS data has been acquired, the on-board device can correctly operate. Therefore, there has been a possibility that a user will continue to use the on-board device without grasping that a constant power source is not connected.

A problem to be solved by the present disclosure is to provide an on-board device and an on-board device self-diagnosis method, which enable the on-board device to detect that the constant power supply line is not connected, and report this fact to a user.

### SUMMARY

An on-board device according to an embodiment of the present disclosure, which enables a GNSS receiver to receive GNSS data and is connectable to both a constant power supply line and an ACC power supply line, includes a memory and first and second processors coupled to the memory. The first processor is configured to determine a status of the GNSS receiver when power is supplied to the ACC power supply line. The second processor is configured to: determine whether the on-board device is connected to the constant power supply line based on the status of the GNSS receiver; and in response to determining that the on-board device is not connected to the constant power supply line, make a report that the on-board device is not connected to the constant power supply line.

### BRIEF DESCRIPTION OF THE DRAWINGS

FIG. 1 is a general configuration block diagram of an on-board device according to an embodiment;

FIG. 2 is a functional block diagram illustrating functions of a processor;

FIG. 3 is a general configuration block diagram of a system controller;

FIG. 4 is a functional block diagram illustrating functions of a control processing unit; and

FIG. 5 is an explanatory diagram of a processing flowchart according to the embodiment.

### DETAILED DESCRIPTION

Embodiments of the present invention will be described below with reference to the accompanying drawings.

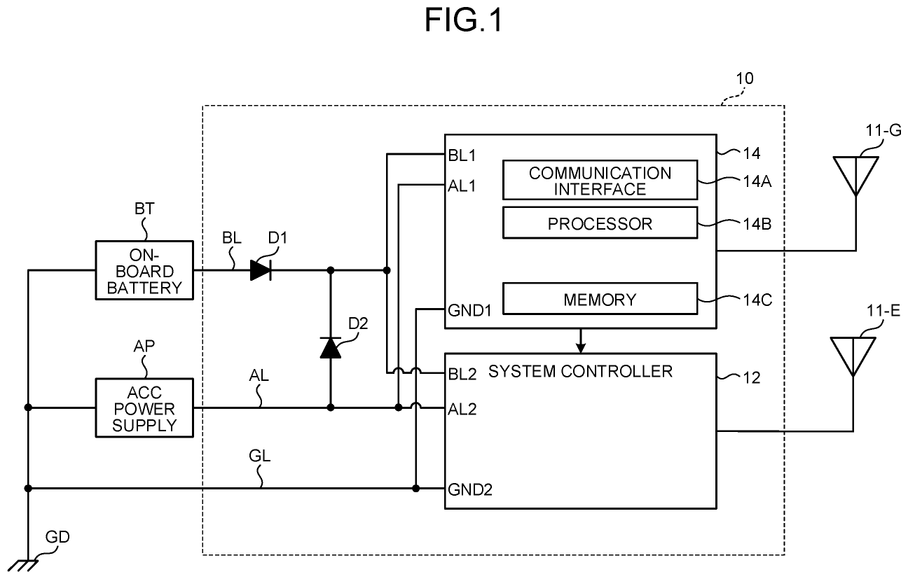

FIG. 1 is a general configuration block diagram of an on-board device according to an embodiment. An on-board device 10 includes an ETC communication antenna 11-E that can perform communication with a roadside device or the like that constitutes an ETC 2.0 system, a GNSS receiving antenna 11-G that can receive GNSS waves from a GNSS satellite, a system controller 12 that controls the entirety of the on-board device 10, a GNSS receiver 14 that performs processing for receiving the GNSS waves that have been received via the GNSS receiving antenna 11-G, generates GNSS data, and outputs the GNSS data to the system controller 12, a backflow prevention diode D1 in which an anode terminal is connected to an on-board battery BT, and a cathode terminal is connected to a constant power supply terminal BL1 of the GNSS receiver 14 and a constant power supply terminal BL2 of the system controller 12, and a backflow prevention diode D2 in which an anode terminal is connected to an ACC power supply AP, and a cathode terminal is connected to the constant power supply terminal AL1 of the GNSS receiver 14 and the constant power supply terminal AL2 of the system controller 12.

By employing the configuration described above, in installing the on-board device 10, even in a case where the on-board device 10 has been installed in a state where a constant power supply is not connected, if an ACC power supply is connected, power can be supplied without the occurrence of backflow or the like, and the on-board device 10 can operate.

Here, an outline of the ETC 2.0 system is described. The ETC 2.0 system is a system in which expressways and vehicles perform information cooperation in real time to provide various types of information (alternative routes, information at the time of disaster, or the like) that are useful for traveling on the expressways, and this provides a comfortable driving environment to drivers.

In the ETC 2.0 system, a roadside device or the like that is called an ITS spot and the on-board device 10 perform bidirectional communication according to the DSRC communication scheme, and various services can be enjoyed. More specifically, information principally relating to expressways of 1000 km ahead is provided, or detailed road information relating to a traveling direction based on a position of a vehicle equipped with the on-board device 10, or the like is provided.

As a result of the above, a comfortable driving environment is provided, and in addition, road traffic is controlled according to the provision of information to achieve a reduction in traffic jams or traffic accidents, improvements in logistical efficiency, improvements in roadside environment, or the like.

In the configuration described above, as illustrated in FIG. 1, the GNSS receiver 14 includes a communication interface 14A that outputs a received signal that has been received from the GNSS satellite on the basis of latest positional information and tine information that are internally stored, a processor 14B that performs the various types of arithmetic processing described later on the basis of received data that has been output by the communication interface 14A, and outputs, to the system controller 12, positioning data (positional information and time information), which is an arithmetic processing result, and a memory 14C that functions as a storage including a volatile storage such as a RAM and a non-volatile storage such as an EEPROM, transitorily decompresses and processes various types of data including the latest positional information and time information, and stores almanac data and ephemeris data that have been received, during a predetermined validity period.

Here, the ephemeris data is orbital data indicating an accurate position of a satellite that is used for position calculation, and peculiar data that is only used by a satellite having a certain satellite number that has transmitted the ephemeris data. A validity period of this ephemeris data is, for example, about four hours in the case of GPS. Stated another way, when the validity period has passed after the acquisition of the ephemeris data, the ephemeris data becomes invalid, and fails to be used in processing.

Furthermore, the almanac data is data that is a simplified version of the ephemeris data, and includes pieces of simple orbital data of all of the currently operating satellites including the satellite that has transmitted the almanac data. A validity period of this almanac data is, for example, about six days in the case of GPS. Stated another way, when the validity period has passed after the acquisition of the almanac data, the almanac data becomes invalid, and fails to be used in processing. The almanac data is used to discover a satellite that can be used for the GNSS receiver 14 to obtain a current position and time.

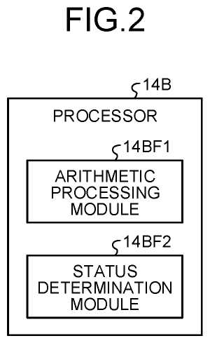

Next, a functional configuration of the processor 14B is described. FIG. 2 is a functional block diagram illustrating functions of the processor. The processor 14B includes an arithmetic processing module 14BF1 and a status determination module 14BF2. The processor 14B executes a program stored in the memory 14C, and therefore these functions are achieved. Note that, for example, at least part of these functions may be implemented by a dedicated hardware circuit. The arithmetic processing module 14BF1 performs various types of arithmetic processing on the basis of the received data that has been output by the communication interface 14A, and outputs, to the system controller 12, positioning data (positional information and time information), which is an arithmetic processing result.

In the configuration described above, the arithmetic processing module 14BF1 receives GNSS data from a plurality (four or more, if possible) of GNSS satellites that are targets of receiving the GNSS data, on the basis of the latest positional information and time information and valid almanac data and ephemeris data that are stored in the memory 14C, performs positioning processing, generates positioning data, which is a result of positioning processing, and outputs the positioning data to the system controller 12.

In this case, in a case where the latest time information is significantly different from the actual time like a case where the latest time information is an initial value (a default value), actual positions of the GNSS satellites are significantly different, and accurate positioning fails to be quickly performed. Therefore, it is desirable that processing be performed on the basis of more accurate time information.

The status determination module 14BF2 determines a status of the GNSS receiver 14 when power is supplied to an ACC power supply line, and determines on the basis of the determined status that the status corresponds to a case where the GNSS receiver 14 is not connected to a constant power supply line BL.

In the configuration described above, the status determination module 14BF2 determines a status of the GNSS receiver when power is supplied to the ACC power supply line. Here, the status indicates an operation status of the GNSS receiver 14, and is classified into three statuses, a cold-start status, a warm-start status, and a hot-start status. Details will be described later.

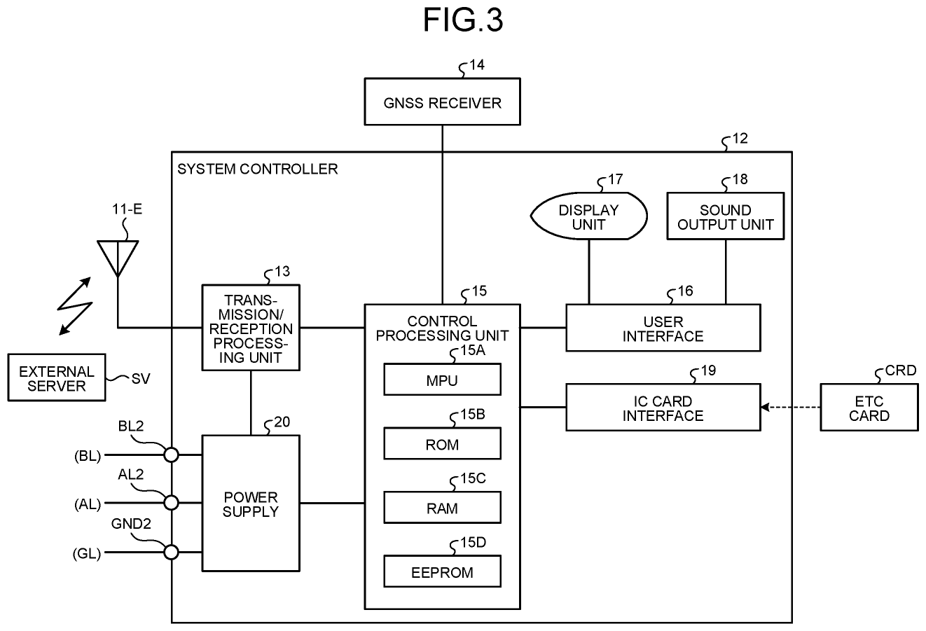

FIG. 3 is a general configuration block diagram of the system controller. As illustrated in FIG. 3, the system controller 12 includes a transmission/reception processing unit 13 that performs processing of transmission to or reception from the ETC 2.0 system (for example, an external server SV) via the communication antenna 11-E, a control processing unit 15 that controls the entirety of the on-board device 10, and processes various types of data, a user interface 16 that performs user interface processing, a display unit 17 that displays various types of information under the control of the user interface 16, a sound output unit 18 that outputs various types of information as sound information under the control of the user interface 16, an IC card interface 19 that performs interface processing on an ETC card CRD, and a power supply 20 that can be connected to the constant power supply line BL from the on-board battery BT via the constant power supply terminal BL2, can be connected to an ACC power supply line AL from the ACC power supply AP via an ACC power supply terminal AL2, can be connected to a ground line GL from a ground GD via a ground terminal GND2, and supplies operation power to each unit of the on-board device 10.

Furthermore, the control processing unit 15 includes an MPU 15A that controls the entirety of the control processing unit 15, a ROM 15B that stores various types of data such as a program in a non-volatile manner, a RAM 15C that decompresses a processing program or transitorily stores processing data, and an EEPROM 15D that stores various types of data in a non-volatile manner and a rewritable manner.

Furthermore, the power supply 20 and the on-board battery BT can be connected by the constant power supply line BL, and the power supply 20 and the ACC power supply AP can be connected by the ACC power supply line AL. Furthermore, the power supply 20 and the ground GD can be connected by the ground line GL. In an actual device configuration, a fuse serving as a safety device is provided on the constant power supply line BL and on the ACC power supply line AL. Furthermore, even in a case where the constant power supply line BL of the on-board device 10 is connected to the ACC power supply line AL, the on-board device 10 can operate.

In the present embodiment, it is assumed that the GNSS receiver 14 is supplied with power from the constant power supply line BL, and stores reception time data in the memory 14C that performs back-up, in a volatile manner, every time the GNSS receiver 14 receives the almanac data or the ephemeris data from the GNSS satellite.

In contrast, it is assumed that the control processing unit 15 stores the reception time data in a non-volatile manner, every time the GNSS receiver 14 receives the almanac data or the ephemeris data from the GNSS satellite.

Specifically, the control processing unit 15 stores the GNSS data in the EEPROM 15D or the like at a timing of predetermined conditions according to the specifications of the on-board device.

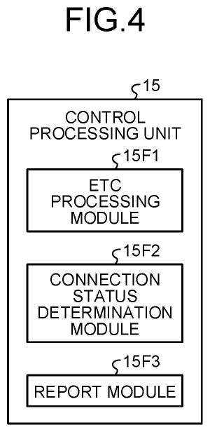

Here, a functional configuration of the control processing unit 15 is described. FIG. 4 is a functional block diagram illustrating functions of the control processing unit. The control processing unit 15 includes an ETC processing module 15F1, a connection status determination module 15F2, and a report module 15F3. The MPU 15A executes a program stored in the ROM 15B, and therefore these functions are achieved. Note that, for example, at least part of these functions may be implemented by a dedicated hardware circuit.

The ETC processing module 15F1 performs communication with the ETC 2.0 system such as the external server SV via the transmission/reception processing unit 13 and the communication antenna 11-E, and provides vehicle information to a side of the ETC 2.0 system. As a result, a servicer of the ETC 2.0 system accumulates and processes data from vehicle information of the ETC 2.0 that has been collected in the external server SV or the like in order to provide various types of information, and performs providing information relating to expressways, acquiring various types of information such as detailed road information relating to a traveling direction based on a position of a vehicle equipped with the on-board device 10, or providing various services, via the ETC processing module 15F1.

The connection status determination module 15F2 determines whether the on-board device 10 is connected to the constant power supply line BL, on the basis of the status of the GNSS receiver 14 that has been determined by the status determination module 14BF2.

The report module 15F3 makes a report in a case where the on-board device 10 is not connected to the constant power supply line BL on the basis of the determination of the connection status determination module 15F2.

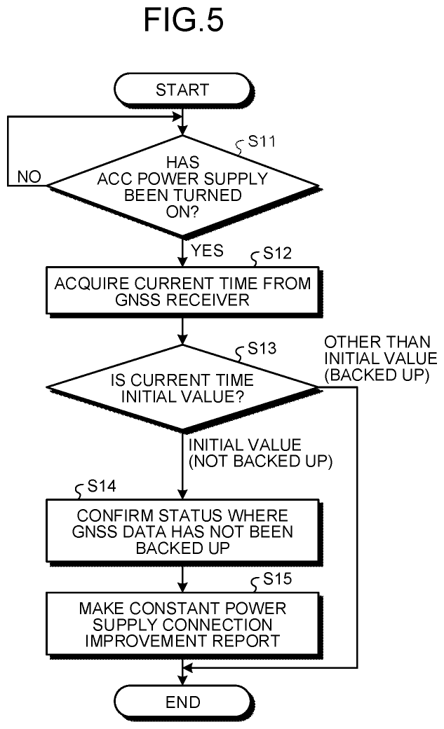

FIG. 5 is an explanatory diagram of a processing flowchart according to the embodiment. First, the control processing unit 15 determines whether the ACC power supply AP has been turned on, and power has been supplied from the ACC power supply AP via the power supply 20 (Step S11). In the determination of Step S11, in a case where power has not yet been supplied from the ACC power supply AP (Step S11; No), it enters into a stand-by state.

In the determination of Step S11, in a case where power has been supplied from the ACC power supply AP (Step S11; Yes), the control processing unit 15 requests that the GNSS receiver 14 output a status. In response to a request from the control processing unit 15, the status determination module 14BF2 of the GNSS receiver 14 outputs, to the system controller 12, a status including time information that is internally stored.

As a result, the control processing unit 15 (the connection status determination module 15F2) of the system controller 12 acquires the status from the status determination module 14BF2 of the GNSS receiver 14 to acquire the time information included in the status (Step S12).

Here, the status of the GNSS receiver is described in detail. Examples of a type of the status to be output from the GNSS receiver 14 (the status determination module 14BF2) can include the cold-start status, the hot-start status, and the warm-start status, as described above.

The cold-start status is a status where both the almanac data and the ephemeris data are invalid. Stated another way, the cold-start status is a status where there is neither almanac data nor ephemeris data that is available to the on-board device 10. In other words, the cold-start status is a status where the almanac data and the ephemeris data need to be newly acquired from the GNSS satellite in order to use the almanac data and the ephemeris data.

Accordingly, the cold-start status is a status where the almanac data needs to be received from any GNSS satellite, a plurality of GNSS satellites that can be actually used in positioning needs to be specified, and the ephemeris data needs to be acquired, in order to perform accurate positioning.

The warm-start status is a status where the ephemeris data is invalid, and only the almanac data is valid. Stated another way, in the warm-start status, in order to perform accurate positioning by using the GNSS data, GNSS satellites from which the GNSS data can be received need to be specified, and the ephemeris data needs to be received.

The hot-start status is a status where both the almanac data and the ephemeris data are valid. Stated another way, in the hot-start status, the on-board device can immediately perform accurate positioning by using the almanac data and the ephemeris data.

Accordingly, a status where the GNSS data is invalid indicates that the GNSS receiver 14 is in the cold-start status.

Next, the control processing unit 15 (the connection status determination module 15F2) determines whether the time information (hereinafter also referred to as current time) included in the status that has been acquired by the processor 14B (the status determination module 14BF2) is a predetermined initial value (for example, a value set at the time of factory shipment: a default value) (Step S13).

In the determination of Step S13, in a case where the control processing unit 15 (the connection status determination module 15F2) determines that the current time is the predetermined initial value (Step S13; initial value), it is confirmed that it is in a status where the GNSS data has not been backed up, that is, a status where the constant power supply is not connected (Step S14).

In a case where it is determined that current time information is the predetermined initial value, that is, when the GNSS data has not been backed up, the control processing unit 15 (the report module 15F3) determines that the on-board device 10 is not connected to the constant power supply line BL on the basis of the determination of the control processing unit 15 (the connection status determination module 15F2). Then, the control processing unit 15 (the report module 15F3) causes the user interface 16 and the sound output unit 18 to make a constant power supply connection improvement report urging a user to connect the constant power supply, by using sound, and terminates the processing (Step S15).

Note that the improvement report can not only be made by using sound, but can also be made by causing the display unit 17 to conduct a display using light, characters, or the like or causing the transmission/reception processing unit to perform communication with external information equipment (a personal computer, a smart phone, or the like).

In contrast, in the determination of Step S13, in a case where the control processing unit 15 (the connection status determination module 15F2) determines that the current time is not the predetermined initial value (Step S13; other than initial value), it is in a status where the GNSS data has been backed up, that is, a status where the constant power supply is connected, and therefore the processing moves on to normal processing (positioning, data communication with the ETC 2.0, and the like).

As described above, according to the present embodiment, the on-board device 10 does not need additional hardware such as a circuit, and the on-board device 10 can make a self-diagnosis on the basis of a determination result of the processor 14B (the statue determination unit 14BF2) of the GNSS receiver, by using the control processing unit 15 (the connection status determination module 15F2) of the system controller 12, and can report a result of the self-diagnosis to a user. More specifically, the on-board device 10 can detect that the constant power supply line BL is not connected, in a case where the current time information is the predetermined initial value, and can report this fact to a user.

In the description above, the on-board device 10 is configured to immediately report to a user that the constant power supply line BL is not connected, in a case where the current time is the predetermined initial value. However, the times of detection can be stored in the EEPROM 15E in an updatable manner, and in a case where detection has been performed plural times, a report can be made.

In the description above, the on-board device 10 that corresponds to the ETC 2.0 system has been described. However, this is not restrictive, and the present disclosure can also be applied to an on-board device that performs cooperation between the GNSS system and a system similar to the ETC 2.0 system.

According to the present disclosure, in a case where it has been determined that the constant power supply line is not connected to the on-board device, this fact is reported, and therefore it can be grasped that the constant power supply line is not connected to the on-board device, and countermeasures can be taken. Thus, services using accurate GNSS data can be provided.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An on-board device that enables a GNSS receiver to receive GNSS data and is connectable to both a constant power supply line and an ACC power supply line, the on-board device comprising:
a memory;
a first processor coupled to the memory and configured to determine a status of the GNSS receiver when power is supplied to the ACC power supply line; and
a second processor coupled to the memory and configured to:
determine whether the on-board device is connected to the constant power supply line based on the status of the GNSS receiver; and
in response to determining that the on-board device is not connected to the constant power supply line, make a report that the on-board device is not connected to the constant power supply line.

2. The on-board device according to claim 1, wherein
the first processor is provided in the GNSS receiver, and
the first processor is configured to determine that the status corresponds to a case where the on-board device is not connected to the constant power supply line, when current time information acquired by the GNSS receiver is a predetermined initial value.

3. The on-board device according to claim 1, wherein
the on-board device includes an electronic toll collection system (ETC) on-board device.

4. The on-board device according to claim 2, wherein
the on-board device includes an electronic toll collection system (ETC) on-board device.

5. An on-board device self-diagnosis method performed by an on-board device that enables a GNSS receiver to receive GNSS data and is connectable to both a constant power supply line and an ACC power supply line, the method comprising:
determining a status of the GNSS receiver when power is supplied to the ACC power supply line;
determining whether the on-board device is connected to the constant power supply line based on the status of the GNSS receiver; and
in response to determining that the on-board device is not connected to the constant power supply line, making a report that the on-board device is not connected to the constant power supply line.

6. The on-board device self-diagnosis method according to claim 5, wherein
the determining the status of the GNSS receiver is performed by the GNSS receiver, and
the determining the status of the GNSS receiver includes determining that the status corresponds to a case where the on-board device is not connected to the constant power supply line, when current time information acquired by the GNSS receiver is a predetermined initial value.

7. The on-board device self-diagnosis method according to claim 5, wherein
the on-board device includes an electronic toll collection system (ETC) on-board device.

8. The on-board device self-diagnosis method according to claim 6, wherein
the on-board device includes an electronic toll collection system (ETC) on-board device.
